(19) United States
(12) Patent Application Publication
(10) Pub. No.: US 2007/0287788 A1
(43) Pub. Date: Dec. 13, 2007

(54) Repair ink and manufacturing method thereof

(76) Inventors: Tai-Junz Chang, Sinjhuang City (TW); Chih-Hao Weng, Gueishan Township (TW); Chi-Hsin Li, Taipei City (TW); Yung-Chieh Chien, Caotun Township (TW); Ken-Hsiung Hsu, Hsinchu City (TW)

Correspondence Address: J.C. Patents, Inc.;Suite 250, 4 Venture, Irvine, CA, 92618, US

(21) Appl. No.: 11/449,281

(22) Filed: Jun. 7, 2006

(51) Int. Cl. C09D 11/00; C08K 3/04

(52) U.S. Cl. 524/495; 523/160

(57) ABSTRACT

The invention is directed to a repair ink suitable for repairing a micro defect of a color pattern. The repair ink comprises a pigment, a monomer having a reactive functional group, an additive, and a solvent. The viscosity of the repair ink is about 40˜350 mPa·sec and the weight percentage of the solvent in the repair ink is about 20˜60 and the weight percentage of the pigment in the repair ink is about 5˜45.

### BACKGROUND OF THE INVENTION

1. Field of the Invention

The invention relates to a repair ink and a manufacturing method thereof, and especially relates to a repair ink for repairing micro defects of a color pattern and a manufacturing method thereof.

2. Description of Related Art

Since demand for displays is increasing, the industry has fully invested in development of related displays, in which the Cathode Ray Tube (CRT) has monopolized the display market for years due to its excellent display quality and mature technology. However, with the emerging concepts of “green”-ness and environmental protection, because of the properties of considerably larger energy consumption and radiation, plus the limited space for flattening of the product structure, it cannot meet the market trend for light, thin, short, small, beautiful, and low power consumption products. Thus, Thin Film Transistor Liquid Crystal Display (TFT LCD) has become the mainstream product in the market due to its superior properties of high definition, high space utilization, low power consumption and no radiation, etc.

The thin Film Transistor Liquid Crystal Display is mainly composed of a Liquid Crystal Display panel (LCD panel) and a back light module, in which the Liquid Crystal Display panel is mainly composed of a thin film transistor array substrate, a color filter substrate, and a liquid crystal layer installed between the two substrates. In addition, the back light module provides the surface light source needed by the Liquid Crystal Display panel to achieve the display effect of the Thin Film Transistor Liquid Crystal Display.

More specifically, the color filter substrate is usually composed of a substrate, a black matrix (BM), a color filter layer and a transparent conductive layer. During the manufacturing of the color filter substrate, there will be unavoidable defects on the black matrix and the color filter layer. Thus, these defects must be repaired to improve the quality of the color filter substrate. ROC Patent Publication No.1228143 discloses an “ink for correcting defects of color patterns and method of correcting said defects”. Components of the correcting ink include a coloring agent, a monomer having a reactive functional group, a polymer, and a solvent in a compounding amount of the solvent of 25-70% based on the total ink weight, and the viscosity of the oil is about 40˜300 mPa·sec.

This correcting ink does not form a projection to cause a new problem even after being coated on a decolorized portion of a white defect, and does not increase the overlapping area between a coated spot and a normal picture element by over-spreading of the spot after coating. In addition, the correcting ink has good stability of physical properties such as viscosity, dispersibility, and chroma in storage and in use. However, there are still several shortcomings when using the ink in the patent, as shown in the following:

I. When it is used for correcting a pattern defect, the blue ink for correcting displays a color saturation lower than that of a normal blue picture element. Thus after correcting, the visual chroma of the decolored part is often relatively lower than that of the original blue picture element. In other words, the repaired part has lighter color.

II. The black ink for correcting is obtained by mixing an ink pigment combination of three colors: red, yellow, and blue, without the use of carbon black pigment. Thus under a wave range of visible light, a part of visible light still has a certain penetration at the repaired part. In other words, the optical density of the repaired part is insufficient.

III. When a reliability test is carried out on the color filter substrate using this correcting ink, the transparent conductive layer at the repaired part is easy to peel off, therefore decreasing the yield of the color filter substrate.

### SUMMARY OF THE INVENTION

Therefore, a purpose of the invention is to provide a repair ink for repairing a micro defect of a black matrix or a color filter layer.

In addition, another purpose of the invention is to provide a method of manufacturing a repair ink to produce a repair ink having high color saturation or optical density.

To achieve the above purposes or other purposes, the invention proposes a repair ink suitable for repairing a micro defect of a color pattern. The repair ink comprises a pigment, a monomer having a reactive functional group, an additive, and a solvent. The viscosity of the repair ink is about 40˜350 mPa·sec and the weight percentage of the solvent in the repair ink is about 20˜60 and the weight percentage of the pigment in the repair ink is about 5˜45.

In one embodiment of the invention, the repair ink further comprises a photoreaction initiator, and the pigment is carbon black.

In one embodiment of the invention, the monomer has more than two reactive functional groups.

In one embodiment of the invention, the repair ink further comprises a polymerization initiator.

In one embodiment of the invention, the repair ink further comprises a pigment dispersant, and the weight percentage of the pigment dispersant in the repair ink is about 0.1˜10.

For the above purposes or other purposes, the invention proposes a method of manufacturing a repair ink, which comprises the following steps: firstly providing a pigment, a monomer having a reactive functional group, an additive, and a solvent; then, the pigment, the monomer having a reactive functional group, the additive and the solvent are mixed to produce the repair ink.

In one embodiment of the invention, the step of mixing to form the repair ink further includes providing a photoreaction initiator, and the pigment is carbon black. Then, the pigment, the monomer having a reactive functional group, the additive, the solvent and the photoreaction initiator are mixed to produce the repair ink.

In one embodiment of the invention, the weight percentage of the solvent in the repair ink is about 20˜60.

In one embodiment of the invention, the viscosity of the repair ink is about 40˜350 mPa·sec.

Based on the above description, a pigment, a monomer having a reactive functional group, an additive, and a solvent are applied in the invention to manufacture a red, green, blue and black repair ink for repairing defects of a color filter layer or a black matrix on a color filter so that there is no obvious difference between the repaired part and the original picture element, thus increasing the availability of the color filter.

It is to be understood that both the foregoing general description and the following detailed description are exemplary, and are intended to provide further explanation of the invention as claimed.

### DESCRIPTION OF EMBODIMENTS

In this description, the term “light” includes all visible or invisible light which may initiate photoreaction of a photoreactive functional group, mainly including ultraviolet, infrared, electron beam etc.

The repair ink of this invention is applicable for repairing a micro defect of a fine colored pattern. The repair ink comprises a pigment, a monomer having a reactive functional group, an additive, and a solvent. In this embodiment, the viscosity of the repair ink is about 40˜350 mPa·sec. In addition, the weight percentage of the solvent in the repair ink is about 20˜60. Each component will be described in detail hereinafter.

In this embodiment, the pigment is produced by Taiwan Nano Technology Corp. Preferably, various organic and inorganic pigments is selected depending on the color of the picture element to be corrected. Specific examples of these organic pigments may be listed in the Color Index(C.I., Issued by the Society of Dyers and Colourists Corp.) and be classified as compound of pigment, for example, the following color index (C.I.)numbers: yellow pigments, such as C.I. Pigment Yellow 1, C.I. Pigment Yellow 3, C.I. Pigment Yellow 12, C.I. Pigment Yellow 13, C.I. Pigment Yellow 83, C.I. Pigment Yellow 138, C.I. Pigment Yellow 139, C.I. Pigment Yellow 150, C.I. Pigment Yellow 180, and C.I. Pigment Yellow 185 and the like; red pigments, such as C.I. Pigment Red 1, C.I. Pigment Red 2, C.I. Pigment Red 3, C.I. Pigment Red 177, and C.I. Pigment Red 254, and the like; blue pigments, such as C.I. Pigment Blue 15, C.I. Pigment Blue 15:3, C.I. Pigment Blue 15:4, and C.I. Pigment Blue 15:6, and the like; green pigments, such as C.I. Pigment Green 7, and C.I. Pigment Green 36, and the like; purple pigments, such as C.I. Pigment Purple 23, and C.I. Pigment Purple 23:19 and the like.

Also, the a forementioned inorganic pigments comprises titanium oxide, barium sulfate, calcium carbonate, zinc white, lead sulfate, yellow lead, red oxide(red ferric iron), cadmium red, ultramarine blue, Prussian blue, chrome oxide green, cobalt green, ocher, titanium black, synthetic iron black, and carbon black and the like. In the invention, the pigments may be used alone or in a mixture of two or more pigments and are not limited to those as mentioned above.

The weight percentage of the pigment in repair ink is about 1˜45, especially preferably 5˜30, and most preferably 9˜25.

In the invention, carbon black may be used in the black repair ink for correcting a defect of a black matrix to achieve higher masking ability. The weight percentage of the carbon black in the repair ink is about 5˜45, especially preferably 5˜30, still most preferably 9˜25. In addition, when the pigment is carbon black, the repair ink further comprises a photoreaction initiator.

The monomer having a reactive functional group in the repair ink plays multiple roles therein:

I. The monomer having a reactive functional group can act as a adhesive. Through adjustment of types and proportion of the monomer having a reactive functional group and the solvent, physical properties such as viscosity and coating property can be properly adjusted to an applicable range.

II. Various types and proportions of the monomer having a reactive functional group can improve the solvent resistance or the heat resistance of the repaired part as well as hardenable film-forming property after coating.

III. Appropriate color saturation and adhesion to a substrate may be achieved by adequately adjusting components and proportion of the pigment and the monomer having a reactive functional group.

IV. The monomer having a reactive functional group is the composing unit for the polymerization reaction.

In the invention, the monomer structure has more than two reactive functional groups or can be an oligomer and possesses good fluidity under normal temperature. Moreover, in addition to adjusting viscosity, coating film-forming property and the like, more importantly, the monomer structure may participate in polymerization cross-link-hardened film forming.

Preferably, when a multifunctional reactive monomer with more than two reactive functional groups in one molecule is used alone or in a mixture of more than two monomers, a sufficient hardening property will be displayed due to higher cross linking density.

The reaction form of the reactive functional groups should be a hardening reaction, such as free radical polymerization, cation polymerization, and anion polymerization. Specifically, a monomer having an ethylene unsaturated bond is preferred for the reactive monomer, which may be excited by the initiator to cause thermal free radical polymerization or directly initiate photo-radical polymerization after being exposed to light. When the reactive functional group of the monomer contains epoxy group, heat hardening and photo cationic polymerization can be applied.

Monomers having an ethylene unsaturated bond are, for example, acrylate monomers having a multifunctional group, such as dipentaerythritol hexamethacrylate, dipentaerythritol pentamethacrylate, pentaerythritol tetramethacrylate, trimethylolpropane trimethacrylate, pentaerythritol trimethacrylate, pentaerythritol methacrylate, diallyl phthalate, tripropylene glycol dimethacrylate, neopentyl glycol dimethacrylate-epoxypropane adduct, ethylene glycol methacrylate, diethylene glycol dimethacrylate, propylene glycol dimethacrylate, dipropylene glycol dimethacrylate, polyethylene glycol dimethacrylate, polypropylene glycol dimethacrylate, hexyl dimethacrylate, neopentyl glycol dimethacrylate, glyceryl dimethacrylate, glyceryl trimethacrylate, glyceryl tetramethacrylate, butanetrimethylolpropane trimethacrylate,1,4-butanediol diacrylate, and the like. Among these, dipentaerythritol hexaacrylate, dipentaerythritol pentamethacrylate, pentaerythritol tetramethacrylate, trimethylolpropane trimethacrylate, pentaerythritol trimethacrylate are preferred due to higher cross linking density and sufficient hardening property, thus are preferred embodiments.

In the invention, there is no special limit on the type of the solvent to be used. Those solvents in which a pigment is well dispersed and a monomer having a reactive functional group is well dissolved are preferred. In addition, more than two solvents may also be applied at the same time.

Examples of solvents are alcoholic solvents such as methanol, ethanol, n-propanol, and isopropanol etc; cellosolve solvents such as methoxyethanol and ethoxyethanol etc; carbitol solvents such as methoxyethoxyethanol and ethoxyethoxyethanol etc; ester solvents such as ethyl acetate, butyl acetate, methyl methoxypropionate, ethyl ethoxypropionate, and ethyl lactate etc; ketone solvents such as acetone, methyl isopropyl acetone, and cyclohexanone etc; cellosolve acetate solvents such as methoxyethyl-acetate, ethoxyethyl acetate and, ethyl cellosolve acetate etc; acetate solvents such as methoxyethoxyethyl acetate, and ethoxyethoxyethyl acetate etc; ether solvents such as diethyl ether, ethylene glycol dimethyl ether, diethylene glycol dimethyl ether, and tetrahydrofuran, etc; amide solvents such as N,N-dimethylformnamide, N,N-dimethylacetamide and N-methylpyrrolidone, etc; lactone solvents such as γ-butyrolactone, etc; unsaturated hydrocarbon solvents such as benzene, toluene, xylene and naphthalene, etc; non-aqueous organic solvents such as n-pentane, n-hexane, n-octane, etc. Among others, the preferred solvents are cellosolve acetate solvents such as methoxyethyl acetate, ethyoxyethyl acetate and ethyl cellosolve acetate, etc; carbitol acetate solvents such as methoxyethoxyethyl acetate and ethoxyethoxyethyl acetate, etc; ether solvents such as ethylene glycol dimethyl ether, diethylene glycol dimethyl ether and propylene glycol diethyl ether, etc; ester solvents such as methyl methoxypropionate and ethyl ethoxypropionate, etc. Especially preferred are: PGMEA(propylene glycol monomethyl ether acetate, Ch₃OCH₂Ch(Ch₃)OCOCH₃), MBA(acetic acid-3-methoxybutyl ester CH₃CH(OCH₃)CH₂CH₂OCOCH₃), DMDG(diethylene glycol dimethyl ether, H₃COC₂H₄OCH₃), or mixtures thereof.

The weight percentage of the solvent in the repair ink is about 20˜60, especially preferably 25˜55, and more preferably 27˜45.

In this embodiment, the repair ink further comprises a pigment dispersant. Also, the use of the pigment dispersant is to improve the dispersion stability of the pigment. The weight percentage of the pigment in the repair ink is about 0.01˜25, especially preferably 0.05˜15, and most preferably 0.1˜10. Specific examples of the pigment dispersant include alkyl amide compounds such as nonanamide, decyl amide, lauryl amide, n-dodecyl cetanyl amide, n-heptadecyl propionamide, N,N-dimethyl lauryl amide, N,N-dihexylacetamide etc; amine compounds such as diethylamine, diheptyl amine, dibutyl cetanyl amine, N,N,N′,N′-tetramethyl methylamine, triethylamine, tributyl amine and trioctylamine etc; amino compounds having hydroxy group such as monoethanolamine, ethanolamine, triethanolamine, N,N,N′,N′-(tetrahydroxyethyl)-1,2-diaminoethane, N,N,N′-tri(hydroxyethyl)-1,2-diaminoethane, N,N,N′,N′-tetra(hydroxyethyl polyhydroxyethylene)- 1,2-diaminoethane, 1,4-bis(2-hydroxyethyl)piperazine and 1-(2-hydroxyethyl)piperazine etc; hexahydronipecotamide, hexahydroisonipecotamide, nicotinamide etc; and others, for example, polycarboxylates such as polyurethane and polyacrylate etc; polyester pigment dispersants with high molecular weight such as unsaturated polyamide, polycarboxylic acid(part)amine salt, ammonium salt of polycarboxylic acid, polycarboxylic acid alkylamine salt, polysiloxane, long-chain polyaminoamide phosphate, modified polycarboxylate containing hydroxy group, amide, and salt formed from reaction of poly(lower alkylene imine) and polyester with free carboxyl. In terms of superior dispersibility at higher colored concentration, polyester pigment dispersants with high molecular weight are preferred.

In this embodiment, the repair ink may further comprise a polymerization initiator. Also, the purpose of adding the polymerization initiator is to improve the reactivity and film-forming hardening rate of a monomer having a reactive functional group. When a monomer having an ethylene functional group is applied, a free radical initiator is usually added. The free radical polymerization initiator may include, for example, acetophenones, diphenylketones, ketals, anthraquinones, 9-thioxanthones, azocompounds, peroxides, 2,3-dialkyldione compounds, disulfide compounds, thiuram compounds, fluoroamine compounds, etc. Specific examples include 1-hydroxy-cyclohexyl-phenyl-one, 2-methyl-1-(4-(thiomethyl)phenyl)-2-morpholinopropan-1-one, benzyl dimethyl ketone, 1-(4-dodecylphenyl)-2-hydroxy-2-methylpropan-1-one, 2-hydroxy-2-methyl-1-penylpropan-1-one, 1-(4-isopropylphenyl)-2-hydroxy-2-methylpropan-1-one, diphenylketone, etc. Among the above, acetophenones, and 9-thioxanthone compound initiator, specifically, 2-benzyl-2-dimethylamino-1-(4-morhpolinophenyl)-butan-1,2-methyl-1-(4-thiomethylphenyl)2-morpholino-propan- 1-one and diethyl-9-oxodibenzthiopyrane are preferred. The initiators can be used alone or in a combination of more than one initiator.

In this embodiment, the additive is a surfactant, which is used to decrease the surface tension of solution while increase the surface smoothness and evenness. Surfactants usually are polysiloxane, modified polysiloxane, polyether-modified polysiloxane and polyester-modified polysiloxane etc; polyacrylate, polyacrylate copolymer, fluorine-modified polyacrylate copolymer etc; or solvents with high boiling point containing surfactant etc.

In this embodiment, the viscosity of the repair ink is about 40˜350 mPa·Sec, preferably 50˜250 mPa·Sec, and most preferably 60˜100 mPa·Sec. If the viscosity of the repair ink is too low, the coated spot is easy to infiltrate and spread after coating, resulting in a defect of color mixture. On the contrary, if the viscosity of the repair ink is too high, the film of the coated spot will be thicker and the color will be deeper, and it's difficult to obtain a smooth surface for the coated spot and a relatively high protrusion will be formed. Thus, if the viscosity of the repair ink is set within the above range, the coated spot will be smooth and no infiltration will be caused, and further, the height of the protrusion will fall within an allowable range.

In addition, when a black repair ink is applied and the film thickness of the hardened black repair ink is 1.9 μm, the optical density is above 3.0, preferably 3.2, and especially preferably 3.4. The defect part corrected by using this black repair ink will not be too obvious, and a good masking effect will be obtained. The manufacturing method of the repair ink according to the invention is described below.

The manufacturing method of the repair ink according to the invention includes the following steps: firstly, providing a pigment, a monomer having a reactive functional group, an additive, and a solvent; then, the pigment, the monomer having a reactive functional group, the additive, and the solvent are mixed to produce the repair ink. The above materials may be added in any order with mixing to achieve proper dispersion.

In addition, in the manufacturing of a black repair ink, the pigment is carbon black. The pigment, a monomer having a reactive functional group, an additive, a solvent, and a photoreaction initiator are mixed to produce the repair ink.

The main use of the repair ink of this invention is to correct a defect of a color filter. However, if desired, the ink may be optionally varied to perform the same correcting effect on defects of other fine colored patterns. In terms of correcting a color filter substrate, correcting on a black matrix may be carried out once it is formed. Alternatively, after any color in the color filter layer is formed, correcting may be carried out on the corresponding color. The correcting may also be carried out together after the black matrix and the color filter layer are completely formed. However, if the correcting is carried out only after a protection layer or a transparent conductive layer is formed, the protection film and transparent conductive layer on the repaired site will be damaged. Thus it is recommended that corrections be made before the protection film or transparent conductive layer is formed.

After the repair ink is coated on the defect part, high temperature heating may be applied to initiate the cross link-hardened film forming of the monomer, since the monomer having a reactive functional group in the repair ink has an ethylene non-saturated bond. Thus, after the defect part is corrected, if the coated portion is made smooth by using a protection layer and a transparent conductive layer, the color filter will have equivalent performance as that of a non-defect product. Considering the balance with colored concentration, the height difference advantageously is −3 μm-+5 μm, especially preferably −2 μm-+3 μm, and more preferably −1 μm-+2 μm.

The invention is illustrated below with reference to A series and B series embodiments, in which the A series embodiment is intended to demonstrate the advantages of the repair ink of this invention while the B series embodiment is directed to black repair ink.

### A Series Embodiment

(1) Pigment dispersions in well-dispersed phase, provided directly by Taiwan Nano Technology Corp., respectively are Manufacturing example A1, Manufacturing example A2 and Manufacturing example A3, as shown in Table A1.

TABLE A1

| | | Manufacturing | | |
|---|---|---|---|---|
| | | examples(Wt %) | | |
| | | A1 | A2 | A3 |
| Pigment | Pigment Red | 25.0 | | |
| | Pigment Blue | | 40.0 | |
| | Pigment Green | | | 25.0 |
| Dispersant | Pigment dispersant with high | 7.0 | 9.0 | 8.5 |
| | molecular weight | | | |
| Solvent | Propylene glycol monomethyl | 68.0 | 51.0 | 66.5 |
| | ether acetate | | | |

(2) According to the proportions as shown in table A2, the pigments of Manufacturing example A1, Manufacturing example A2 and Manufacturing example A3 etc, provided by Taiwan Nano Technology Corp. are in one portion mixed with a monomer having a reactive functional group, a solvent, and an additive. Viscosity is measured by a viscometer and if necessary, additional portion of the solvent may be used to adjust the viscosity. Components of the resulted repair ink are shown in Table A2.

TABLE A2

| | | Embodiment(Wt %) | | |
|---|---|---|---|---|
| | | A1 | A2 | A3 |
| Pigment | Manufacturing example A1 | 61.32 | | |
| | Manufacturing example A2 | | 55.40 | |
| | Manufacturing example A3 | | | 56.50 |
| Monomer | Dipentaerythritol hexaacrylate | 38.43 | 44.35 | 42.33 |
| Additive | surfactant | 0.10 | 0.10 | 0.10 |
| Solvent | Propylene glycol monomethyl ether | 0.15 | 0.15 | 1.07 |
| | acetate | | | |

TABLE A3

| | | Embodiment(Wt %) | | |
|---|---|---|---|---|
| | | A1 | A2 | A3 |
| Pigment | Pigment Red | 15.34 | | |
| | Pigment Blue | | 22.16 | |
| | Pigment Green | | | 14.12 |
| Pigment | Pigment dispersant with high molecular | 4.29 | 4.99 | 4.8 |
| dispersant | weight | | | |
| Monomer | Dipentaerythritol hexaacrylate | 38.41 | 44.33 | 42.31 |
| Additive | surfactant | 0.10 | 0.10 | 0.10 |
| Solvent | Propylene glycol monomethyl ether | 41.86 | 28.42 | 38.67 |
| | acetate | | | |

The assessment of related physical properties is carried out on the above embodiments A1 to A3.

I. Measurement and Assessment of Height Difference at the Repaired Part.

The measurement of height difference at the repaired part is based on the film thickness measured by a stylus measuring apparatus. The so-called height difference refers to the height difference between the repaired part and the surrounding part. If the height difference is above 3 μm, then the correcting on the color filter substrate is not good. Thus, it is determined to be bad.

II. Visual Assessment of the Repaired Part.

The corrected color filter substrate is put on a backlight to observe the repaired part for determining whether it is acceptable. If it is obviously found that as the repair ink flows, an overly large corrected area or too thin color occurs at the repaired part, it is determined to be bad.

III. Reliability Test on the Repaired Part.

A color filter substrate with the repaired part covered with a transparent conductive layer is respectively put into isopropanol(RT 25° C./30 mins), ethanol(RT 25° C./30 mins), and N-methyl pyrrolidinone(RT 45° C./1 min/3 cycles) solution etc.. Microscope observation is carried out after washing and drying. If there is no abnormal status such as peeling off or chapping, it is acceptable.

The results of viscosity, solids concentration, pigment concentration in solids, concentration of adhesive, measurement of protrusion height, visual assessment of the corrected part, and drug tolerance testing for embodiments A1-A3 are shown in Table A4.

TABLE A4

| | Embodiment | | |
|---|---|---|---|
| | A1 | A2 | A3 |
| Viscosity (mPa · sec) | 67 | 75 | 65 |
| Solids concentration (Wt %) | 58 | 72 | 61 |
| Pigment concentration | 26.45 | 30.78 | 23.15 |
| in solids (Wt %) | | | |
| Concentration of adhesive | 66.22 | 61.57 | 69.36 |
| in solids (Wt %) | | | |
| Measurement of height | −1.0 | −1.0 | −0.8 |
| difference (μm) | | | |
| Visual assessment on | Fine | Fine | Fine |
| the repaired part | | | |
| Reliability test | Acceptable | Acceptable | Acceptable |

As seen from the above results, in relative embodiment A1-A3, the coating property on the repaired part is good and the visual appearance, protrusion height and reliability test after correcting and hardening are all fine.

The following is directed to the black repair ink, i.e., B series embodiment.

### B Series Embodiment

(1) Black pigment dispersion in a well-dispersed phase, provided directly by Taiwan Nano Technology Corp. is manufacturing example B1, as shown in Table B1.

TABLE B1

| | | Manufacturing |
|---|---|---|
| | | example(Wt %) |
| | | B1 |
| Pigment | Pigment Black | 25.0 |
| Dispersant | Pigment dispersant with | 7.0 |
| | high molecular weight | |
| Solvent | Propylene glycol monomethyl | 68.0 |
| | ether acetate | |

(2) According to the proportion in table B2, the pigment of Manufacturing example B1 provided by Taiwan Nano Technology Corp. is in one portion well mixed with a monomer having a reactive functional group, a solvent, an additive and a photoreaction initiator. Viscosity is measured by a viscometer and if necessary, additional portion of the solvent may be added to adjust the viscosity. Components of the resulted repair ink are shown in Table B2.

TABLE B2

| | | Embodiment(Wt %) |
|---|---|---|
| | | B1 |
| Pigment | Manufacturing example B1 | 55.80 |
| Monomer | Dipentaerythritol hexaacrylate | 41.84 |
| Polymerization | Acetophenone initiator | 2.11 |
| initiator | | |
| Additive | Surfactant | 0.10 |
| Solvent | Propylene glycol monomethyl | 0.15 |
| | ether acetate | |

TABLE B3

| | | Embodiment(Wt %) |
|---|---|---|
| | | B1 |
| Pigment | Pigment Black | 13.95 |
| Pigment dispersant | Pigment dispersant with | 3.91 |
| | high molecular weight | |
| Monomer | Dipentaerythritol | 41.84 |
| | hexaacrylate | |
| Polymerization initiator | Acetophenone initiator | 2.09 |
| Additive | Surfactant | 0.10 |
| Solvent | Propylene glycol | 41.86 |
| | monomethyl ether acetate | |

The assessment of related physical properties is carried out on the above embodiment B1.

I. Measurement and Assessment of Height Difference at the Repaired Part.

The measurement of height difference at the repaired part is based on the film thickness measured by a stylus measuring apparatus. The so-called height difference refers to the height difference between the repaired part and the surrounding part. If the height difference is above 3 μm, then the correcting on the color filter substrate is not good. Thus, it is determined to be bad.

II. Visual Assessment of the Repaired Part.

The corrected color filter substrate is put on a backlight to observe the repaired part for determining whether it is acceptable. If it is obviously found that as the repair ink flows, an overly large corrected area or too thin color occurs at the repaired part, it is determined to be bad.

III. Reliability Test on the Repaired Part.

A color filter substrate with the repaired part covered with a transparent conductive layer is respectively put into isopropanol(RT 25° C./30 mins), ethanol(RT 25° C./30 mins), and N-methyl pyrrolidinone(RT 45° C./1 min/3 cycles) solution etc.. Microscope observation is carried out after washing and drying. If there is no abnormal status such as peeling off or chapping, it is acceptable.

The results of viscosity, solids concentration, pigment concentration in solids, concentration of adhesive, measurement of protrusion height, visual assessment of the corrected part, and drug tolerance testing for the above embodiment B1 are shown in Table B4.

TABLE B4

| | Embodiment |
|---|---|
| | B1 |
| Viscosity (mPa · sec) | 73 |
| Solids concentration (Wt %) | 62 |
| Pigment concentration in solids (Wt %) | 22.50 |
| Concentration of adhesive in solids (Wt %) | 67.48 |
| Measurement of height difference (μm) | +0.5 |
| Visual assessment on the repaired part | Fine |
| Reliability test | Acceptable |

As seen from the above results, in relative embodiment B1, the coating property on the repaired part is good and the visual appearance, protrusion height, and reliability test after correcting and hardening are all fine.

To further illustrate difference between prior art and this invention, the comparisons of components, manufacturing method, and usage of repair ink are carried out below.

TABLE 1
Comparison of components in repair ink of prior art and this invention

| | Prior | This | |
|---|---|---|---|
| Components | art | invention | Notes |
| Pigment | ◯ | ◯ | Prior art: black pigment is made |
| | | | of red, yellow, and blue. |
| | | | This invention: black pigment is |
| | | | made of carbon black |
| Pigment dispersant | ◯ | ◯ | |
| Polymer | ◯ | X | |
| Monomer | ◯ | ◯ | |
| Photopolymerization | ◯ | X | Prior art: addition in 4 colors |
| initiator | | | This invention: addition in |
| | | | black, no in RGB |
| Polymerization | ◯ | X | |
| terminator | | | |
| Additive | X | ◯ | |
| Solvent | ◯ | ◯ | |

(Note: ◯ stands for addition; X stands for no addition).

TABLE 2
Comparison of manufacturing process of prior art and this invention.

| | Red, blue, green repair ink | | Black repair ink | |
|---|---|---|---|---|
| Prior art | (1) | Coloring agent is dispersed in a solvent to form a coloring agent | | |
| | | dispersion. | | |
| | (2) | A monomer having a reactive functional group is mixed with a | | |
| | | polymer and a polymerization terminator is added to produce a varnish. | | |
| | (3) | The coloring agent dispersion is mixed with the varnish to produce | | |
| | | an ink, i.e., repair ink. | | |
| This | (1) | Appropriate amounts of a pigment, a | (1) | Appropriate amounts of |
| invention | | monomer having a reactive functional | | a pigment, a monomer |
| | | group, an additive, and a solvent are | | having a reactive |
| | | weighed through a precise balance and put | | functional group, an |
| | | into the same container. | | additive, a photoreaction |
| | (2) | Mix the materials by an agitator at the | | initiator and a solvent are |
| | | maximum speed until uniformly. | | weighed by a precise |
| | | | | balance and put into the |
| | | | | same container. |
| | | | (2) | Mix the materials by an |
| | | | | agitator at the maximum |
| | | | | speed until uniformly. |

TABLE 3
Comparison of the usage of repair ink in prior art and in this invention.

| | Red, blue, green repair ink | Black repair ink |
|---|---|---|
| Prior art | Coating→ultraviolet light hardening→ | |
| | high temperature curing | |
| This invention | Coating→ high temperature curing | Coating→ high |
| | | temperature curing |

To sum up, the repair ink and manufacturing method thereof according to the invention at least has the following advantages.

I. The repair ink of this invention at least contains a pigment, a monomer having a reactive functional group, an additive, and a solvent. When manufacturing, there is no need to prepare various solutions respectively and then mix them together; but directly put the above materials in a single container in order to produce the repair ink with proper properties such as viscosity by adequately stirring them into an even dispersed phase.

II. As compared with black repair ink made of red, yellow, and blue pigments in prior art, carbon black is used as a pigment component of repair ink in this invention. When the film thickness is 1.9 μm, the optical density may be above 3.0 and such a defect part may be substantially masked after repairing.

III. Only heat is needed when the red, green, and blue repair ink of the invention is coated on a defect part, so that a monomer having a reactive functional group may perform a cross-linking reaction to completely harden. If the above black repair ink made of carbon black is applied, light irradiation is still needed after coating so that the surface of the repaired part may instantly harden once. Then, the high temperature curing may be carried out on the repaired part.

It will be apparent to those skilled in the art that various modifications and variations can be made to the structure of the present invention without departing from the scope or spirit of the invention. In view of the foregoing descriptions, it is intended that the present invention covers modifications and variations of this invention if they fall within the scope of the following claims and their equivalents.

What is claimed is:

1. A repair ink suitable for repairing a micro defect of a color pattern, comprising:
a pigment;
a monomer having a reactive functional group;
an additive, and
a solvent, wherein the viscosity of the repair ink is about 40˜350 mPa·sec and the weight percentage of the solvent in the repair ink is about 20˜60 and the weight percentage of the pigment in the repair ink is about 5˜45.

2. The repair ink in claim 1 further comprising a photoreaction initiator, and the pigment is carbon black.

3. The repair ink in claim 1, wherein the monomer has at least two reactive functional groups.

4. The repair ink in claim 1 further comprising a polymerization initiator.

5. The repair ink in claim 1 further comprising a pigment dispersant, and the weight percentage of the pigment dispersant in the repair ink is about 0.1˜10.

6. A method of manufacturing a repair ink, comprising:
providng a pigment, a monomer having a reactive functional group, an additive, and a solvent, and
mixing the pigment, the monomer having a reactive functional group, the additive, and the solvent to produce the repair ink.

7. The method of manufacturing a repair ink in claim 6, in which the step of mixing to produce the repair ink further includes:
providing a photoreaction initiator, and the pigment is carbon black and;
mixing the pigment, the monomer having a reactive functional group, the additive, the solvent and the photoreaction initiator to produce the repair ink.

8. The method of manufacturing a repair ink in claim 6, wherein the weight percentage of the solvent in the repair ink is about 20˜60.

9. The method of preparing repair ink in claim 6, wherein the viscosity of the repair ink is about 40˜350 mPa·sec.
